(19) United States
(12) Patent Application Publication
(10) Pub. No.: US 2008/0253257 A1
(43) Pub. Date: Oct. 16, 2008

(54) Phase-Conjugate Read-Out in a Holographic Data Storage

(75) Inventor: Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,535

(22) PCT Filed: Jun. 20, 2005
(86) PCT No.: PCT/IB05/52017

§ 371 Date: Dec. 13, 2006

(30) Foreign Application Priority Data
Jun. 24, 2004 (EP) 04300396.1

(51) Int. Cl. G11B 7/00

(52) U.S. Cl. 369/103

(57) ABSTRACT

The invention relates to a holographic data storage medium (4) in which there are sections (20) which are used for data storage and sections (21) which are not. A diffractive structure (30a, 30b) is provided in respect of one or more of the unused sections (21), possibly at each of the boundaries between the used (20) and unused sections (21) or within the volume of a respective unused section (21) of the data storage volume. During read-out, a reference wave (6) is diffracted by the diffractive structure (30b) such that it enters a used section (20) (from the right) in a direction substantially perpendicular to the optical axis (16) of the signal wave (26). During recording, a reference wave (2) is diffracted by the diffractive structure (30a) such that it enters the used section (20) (from the left) in a direction substantially perpendicular to the optical axes (1b) of the signal wave (1).

### FIELD OF THE INVENTION

This invention relates to holographic data storage and, more specifically to phase conjugate holographic storage and read-out of data.

### BACKGROUND OF THE INVENTION

Holographic memory is a promising technology for data storage, which uses a three-dimensional medium to store data. In the case of optical and hard-disc storage, data bits stored on a storage medium can only be read out sequentially, whereas in the case of page-oriented storage systems, such as holographic data storage systems, stored data can be accessed a page at a time, i.e. a group of N bits is read out simultaneously, wherein such a group of N pixels is known as a ‘data page’. The storage medium can be grouped in spatially separated areas or volumes, each containing M data pages. Such a group of M data pages is known as a ‘book’, and the process of stepping through data pages k=1 to k=M within a book is known as ‘multiplexing’.

Holographic memory is a true three-dimensional storage arrangement which leads to increases in storage capacity and data access speed. Furthermore, there are very few moving parts required, in comparison with conventional optical and hard-disc storage systems, such that the limitations of mechanical motion are minimised.

Holographic memory uses a photosensitive material to record interference patterns of a reference beam and a signal beam of coherent light, where the signal beam is transmitted by or reflected off an object or it contains data in the form of light and dark areas. The nature of the photosensitive material is such that the recorded interference pattern can be reproduced by applying a beam of light to the material that is identical to the reference beam. The resulting light that is reconstructed by the medium will take on the original data structure of the signal beam and will be collected on a detector array. Many holograms can be recorded in the same space by changing the angle or the wavelength of the incident light, and an entire page of data is also accessed in this way.

Referring to FIGS. 1(a) to 1(c) of the drawings, there is illustrated schematically the underlying principle of holographic data storage. Referring to FIG. 1(a), during recording of data, a signal wave 1 and a reference wave 2 interfere in a region 3 of a holographic medium 4. Information can be stored by modulating the amplitude of the signal wave during recording, e.g. by turning the signal amplitude on/off. The interference pattern is recorded as a refractive index modulation 5, as shown schematically in FIG. 1(b). As shown in FIG. 1(c), during data read-out, the signal wave is switched off, and when the interference region 3 with the grating pattern 5 is illuminated by the reference wave 2, the signal wave 6 is reconstructed by diffraction at the exit side of the holographic medium 4 and travels to a photo-detector (not shown).

Referring to FIG. 2 of the drawings, a holographic storage system is illustrated schematically wherein a light source 1 emits a coherent light beam 2 that is split by a beam splitter 3 into a reference wave 4 and a signal wave 5. The reference wave 4 is directed by a mirror 6 and a rotatable mirror 7 towards a holographic storage medium 8. The signal wave passes a Spatial Light Modulator 9, a beam splitter 10 and is incident on a lens 11. The lens focuses the signal wave into the medium 8 where it interferes with the reference wave to record interference gratings. In a phase-conjugate arrangement a second reference arm (not drawn) is present, illuminating the medium during readout with a wave that is propagated in a direction opposite to the reference wave during recording. The reconstructed signal beam then propagates back into the system, is collimated by the lens 11 and directed towards a pixelated detector 12 by the beam splitter 10.

A group of N signal waves can be recorded simultaneously and read out simultaneously by using a so-called Spatial Light Modulator (SLM), a pixelated detector such as a CCD or CMOS-sensor, and a set of lenses. An SLM consists of N pixels that can be addressed independently. Each pixel changes the complex amplitude of light that passes through it. In the most simple form, light is either fully transmitted or fully absorbed. The cross-section of a light beam that has passed the SLM will take on a checkerboard pattern, as shown in FIG. 4 of the drawings which illustrates schematically a checkerboard pattern representing a data page. As will be apparent to a person skilled in the art, more complex SLMs are possible (i.e. which modulate amplitude and/or phase and/or polarization), but these will not be considered in any further detail herein.

Referring to FIGS. 3(a) and 3(b) of the drawings, there is illustrated schematically the principle of recording and read-out of an entire page.

Referring to FIG. 3(a), during recording, the signal wave 1 and reference wave 2 interfere in region 3 of the holographic medium 4. In this case, the signal wave 1 arises by passing through a Spatial Light Modulator (SLM) 15 that transforms the beam cross-section into a checkerboard of N pixels that are either bright or dark. This checkerboard pattern is imaged by a lens 16 onto the holographic medium 4. Each SLM-pixel position corresponds to a different angle of incidence within the converging cone of light. The interference patterns between (on average) N on-pixels and the reference wave are recorded by the medium as a refractive index modulation in the interference region 3, as before.

Referring to FIG. 3(b) of the drawings, during read out, when the medium 4 is illuminated by the reference wave 2, the signal wave 6 is reconstructed at the exit side of the medium, and imaged by a lens 18 onto a pixelated photo-detector (e.g. CCD-sensor) 19.

There are several methods of multiplexing the M data pages that make up a book located in a certain volume of the holographic medium. One important example is (in-plane) angular multiplexing, in which the angle α between the reference beam and the optical axis takes values α₁, α₂, α₃, . . . α_{M}, as the drive steps through the M data pages, and these angles are chosen such that only the data page k is reconstructed at the pixelated photo-detector when the reference angle is set to value αₖ during read-out.

Thus, referring to FIGS. 5(a) and 5(b) of the drawings, there is illustrated schematically the principle of in-plane (angular) multiplexing, wherein the angle between the optical axis of the signal wave 1 and the reference wave 2 is set to αₖ when data page k is recorded, as shown in FIG. 5(a), whereas the angle is set to αₖ₊₁ when data page k+1 is recorded, as shown in FIG. 5(b), etc. In this way, M data pages of N pixels each are stored in the same 3D-region of the holographic medium.

It should be noted here that the useful volume fraction of a holographic medium addressed using angular multiplexing tends to be, at best, around 50%.

Referring to FIG. 6 of the drawings, a holographic medium 4 with a top surface 4a and a bottom surface 4b has a thickness d. The signal wave 1 has outer rays 1a and 1c and a central ray 1b along the optical axis (broken line), and has a numerical aperture NA, which (assuming that it is sufficiently small compared to 1) is equal to the top angle of the converging cone of light. The signal wave does not have a well-defined narrow focal point because it is not uniform (it is modulated with the checkerboard pattern). In practice, it occupies the full shaded volume 20, which has a width d*NA and a height d. The reference wave 2 has outer rays 2a and inner rays 2b, and makes an angle of (at least) NA with the optical axis. During the recording phase, the white portion 21 is then also written, but in this part there is no interference between the signal and reference waves, so the white portion 21 is not used to store data. The next book of M data pages can be written at the shaded portion 22. Thus, it is apparent that only about 50% of the holographic medium can be used to store data.

The holographic data readers described above with reference to FIGS. 1(a) to 1(c) and FIGS. 3(a) and 3(b) are clearly of a transmissive type construction, which means that the detection branch (with the pixelated photo-detector) and the signal branch (with the SLM) are on opposite sides of the holographic storage medium. However, this complicates the optics and mechanics of the holographic drive. For example, in order to achieve the required high density and image quality, a short focal length lens system corrected for all aberrations is required. Furthermore, the need to provide the reference branch and the signal branch on opposite sides of the holographic medium does not lend itself to the construction of a compact drive.

These problems may be at least partially overcome by making use of so-called phase-conjugate read-out. After recording the object beam from the SLM with a reference beam, the hologram may be reconstructed during read-out with a phase-conjugate (time-reversed copy) of the original reference beam. The diffracted wavefront then retraces the path of the incoming object beam, cancelling out any accumulated phase errors. In general, this type of arrangement was proposed with the intention to allow data pages to be retrieved with high fidelity using a low-performance lens, from storage materials fabricated as multimode fibres, or even with no lens at all, for an extremely compact system.

In more detail, referring to FIGS. 7(a) and 7(b) of the drawings, there is illustrated schematically the principle of recording and read-out using the phase-conjugate method.

During recording, with reference to FIG. 7(a), the signal wave 1 and the reference wave 2 interfere in a region 3 of the holographic medium 4. The signal wave 1 arises by passing the beam through a Spatial Light Modulator (SLM) 15 that transforms the beam cross-section into a checkerboard of N pixels that are either bright or dark. This checkerboard pattern passes a beamsplitter 23 and is imaged by a lens 16 onto the holographic medium 4. Each SLM-pixel position corresponds to a different angle of incidence within the converging cone of light 1. The interference patterns between the (on average) N on-pixels and the reference wave are recorded by the medium as a refractive index modulation in the interference region 3.

During read-out, with reference to FIG. 7(b), when the medium 4 is illuminated by the reference wave 6, with the opposite direction of propagation to that of the reference wave 2 during recording, the signal wave is reconstructed at the entrance side of the medium 4, and imaged by the same lens 16 onto a pixelated photo-detector (e.g. CCD-sensor) 19. As stated above, this arrangement improves the opto-mechanical construction because a single lens 16 is used in the recording and read-out phases. However, the reference wave 6 during read-out is now incident from the opposite side of the medium, such that this arrangement is clearly not a fully reflective holographic reader, which is highly desirable for the purpose of further reducing the size of the drive while maintaining high imaging quality.

### OBJECT AND SUMMARY OF THE INVENTION

It is an object of the present invention to provide a holographic storage medium for use in an apparatus and method for phase-conjugate read-out in a holographic data storage system, which results in a fully reflective system. It is also an object of the invention to provide a method of manufacturing a holographic storage medium and a holographic data storage system for use with such a holographic storage medium.

In accordance with the present invention, there is provided a holographic storage medium comprising a data storage volume comprising a plurality of sections in which data is recordable, and at least one section which is not recordable, the, or at least one of, said non-recordable sections comprising a diffractive structure.

In one exemplary embodiment, the diffractive structure, which is preferably a planar diffractive structure, is located at one or more of the boundaries between said sections which are not recordable, and adjacent sections of said data storage volume which are recordable.

In an alternative exemplary embodiment, the medium comprises a diffractive structure occupying at least a portion of the volume of one or more of the sections which are not recordable. A significant advantage of this particular embodiment is that it enables the diffractive structure(s) to be made of the same photosensitive material from which the recordable sections are made.

It will be appreciated that a signal wave representative of data recorded on the medium defined above can be reproduced by illuminating the medium with a reference wave such that it is incident on the diffractive structure, wherein the diffractive structure is arranged and configured to direct the reference wave in a direction substantially perpendicular to the optical axis of the signal wave through an adjacent recordable section to an interference region.

Also in accordance with a present invention, there is provided a method of manufacturing a holographic storage medium as defined above, comprising determining the sections of said data storage area which are recordable and sections thereof which are not recordable, and providing a diffractive structure in respect of one or more of said sections which are not recordable.

Further in accordance with the present invention, there is provided a method of phase-conjugate read-out of data in respect of a holographic medium as defined above so as to reproduce a signal wave representative of data recorded thereon, the method comprising illuminating the holographic storage medium with a reference wave such that it is incident on a diffractive structure provided in respect of a non-recordable section of the data storage area and said diffractive structure causes the reference wave to be directed in a direction substantially perpendicular to the optical axis of said signal wave through said recordable section to an interference region, and detecting a resultant reconstructed signal wave.

Still further in accordance with the present invention, there is provided apparatus for phase-conjugated read-out of data in respect of a holographic medium as defined above so as to reproduce a signal wave representative of data recorded thereon, the apparatus comprising means for illuminating the holographic storage medium with a reference wave such that it is incident on a diffractive structure provided in respect of a non-recordable section of the data storage area and said diffractive structure causes the reference wave to be directed in a direction substantially perpendicular to the optical axis of said signal wave through said recordable section to an interference region, and means for detecting a resultant reconstructed signal wave.

Also in accordance with the present invention, there is provided a holographic data storage system comprising apparatus for phase-conjugate recording of data on a holographic data storage medium as defined above and apparatus defined above for phase-conjugate read-out of data in respect of said holographic data storage medium, the apparatus for phase-conjugate recording of data comprising means for directing a signal wave toward an interference region within a recordable section of said holographic data storage medium, means for illuminating the holographic storage medium with a reference wave such that it is incident on a diffractive structure provided in respect of a non-recordable section of the data storage area and said diffractive structure causes the reference wave to be directed in a direction substantially perpendicular to the optical axis of said signal wave through said recordable section to said interference region, and means for recording an interference pattern created by interference of said signal wave and said reference wave at said interference region as a refractive index modulation.

The diffractive structure (which may be substantially planar) may be provided at a boundary between a recordable and a non-recordable section. Alternatively, the non-recordable section may encompass the diffractive structure in the bulk of its volume. As stated above, this results in the advantage that the diffractive structure can be made of the same photosensitive material as the recordable section(s).

The reference waves for both data recording and read-out are incident on the holographic data storage medium from the same side thereof, but, beneficially, the reference wave during read-out of data enters said recordable section from a first direction and the reference wave during recording of data enters the recordable section from a second, opposite, direction. In one exemplary embodiment of the invention, the optical axis of the signal wave is substantially perpendicular to the plane of the storage medium. In a preferred embodiment, the signal wave is generated by passing a scanning beam through a spatial light modulator (SLM). An optical element, such as a lens may be provided to image the signal wave onto the holographic medium. It will be appreciated, however, that the reference waves do not need to pass through the lens or other optical element through which the signal wave passes, as a result of which the overall structure can be simplified relative to the prior art, and this also eliminates the need for any consideration of the reference waves in the design and selection of the optical element.

These and other aspects of the present invention will be apparent from, and elucidated with reference to, the embodiment described herein.

An embodiment of the present invention will now be described by way of example only and with reference to the accompanying drawings, in which:

### BRIEF DESCRIPTION OF THE DRAWINGS

FIGS. 1(a) to 1(c) depict a schematic diagram illustrating the principle of holographic data storage;

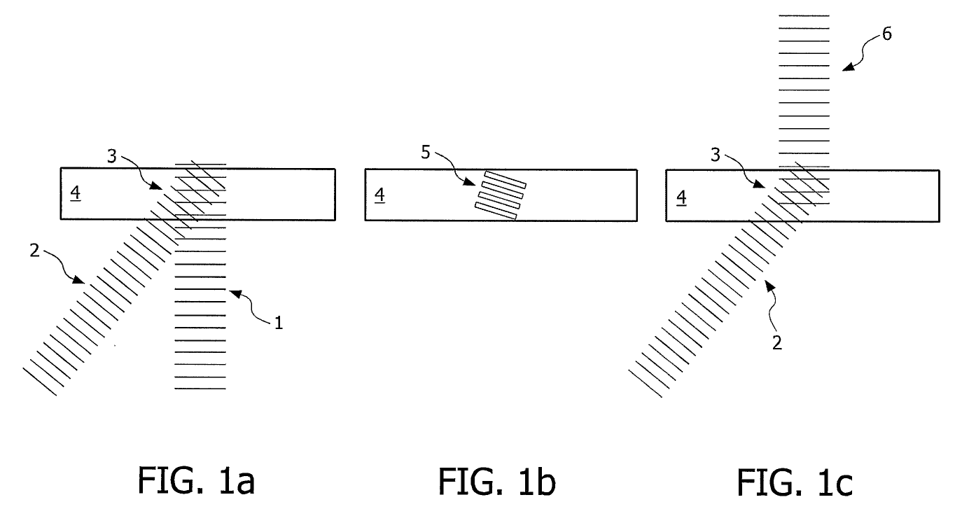

FIG. 2 is a schematic diagram illustrating a holographic storage system;

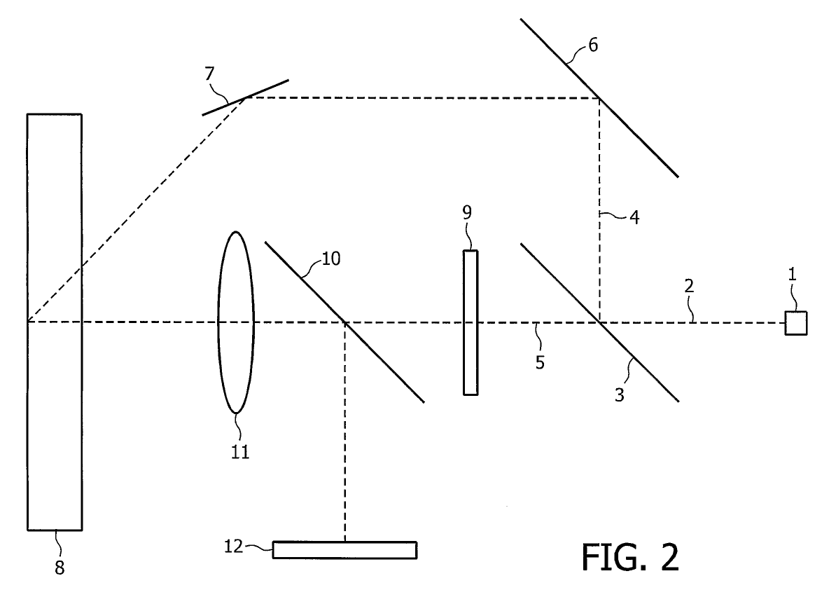

FIGS. 3(a) and 3(b) depict a schematic diagram illustrating the principle of recording and read-out of an entire page;

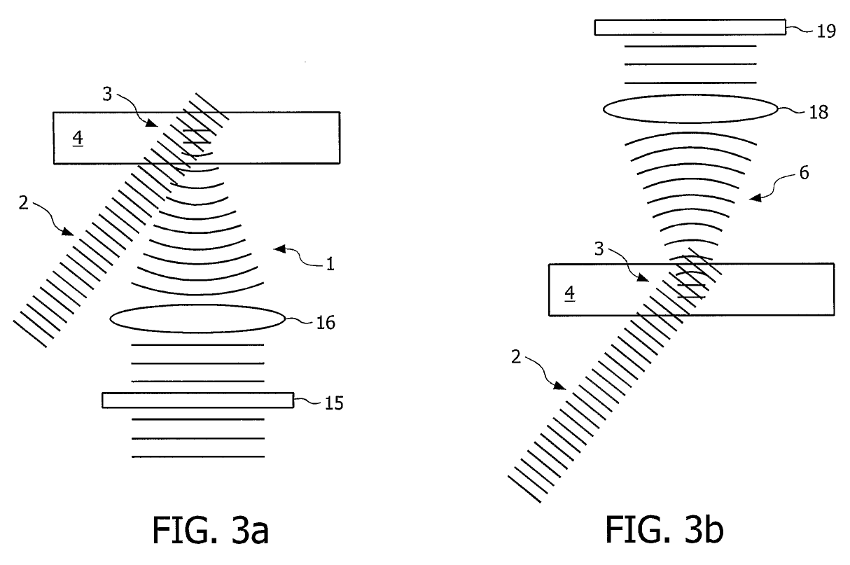

FIG. 4 illustrates a checkerboard pattern representing a data page;

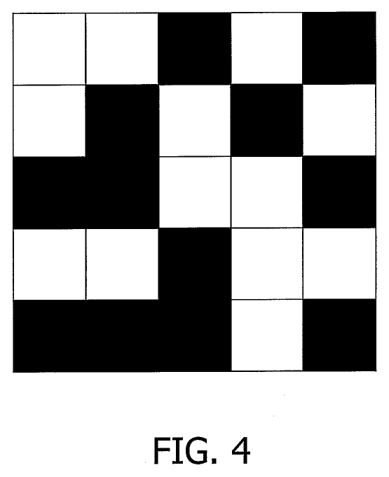

FIGS. 5(a) and 5(b) depict a schematic diagram illustrating the principle of (in-plane) angular multiplexing;

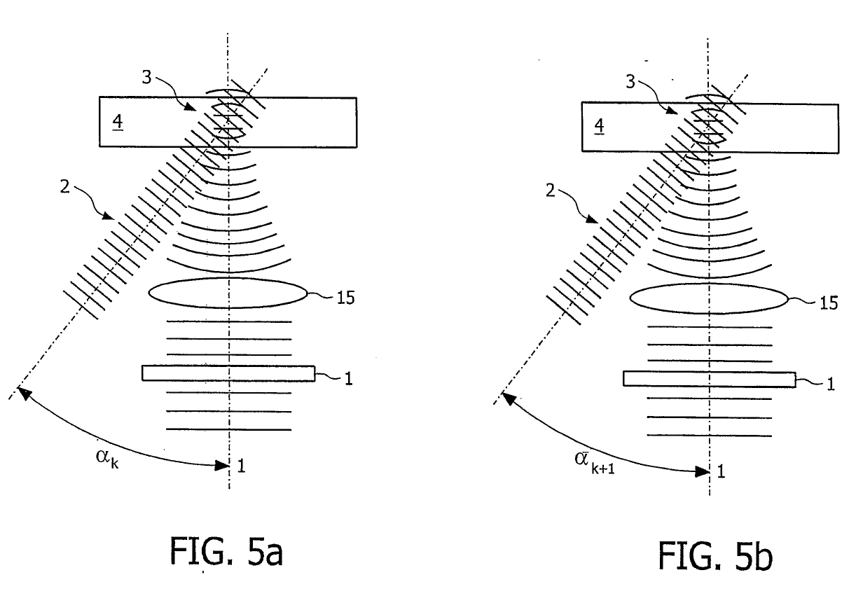

FIG. 6 is a schematic diagram illustrating the useful volume fraction of a holographic medium addressed with angular multiplexing;

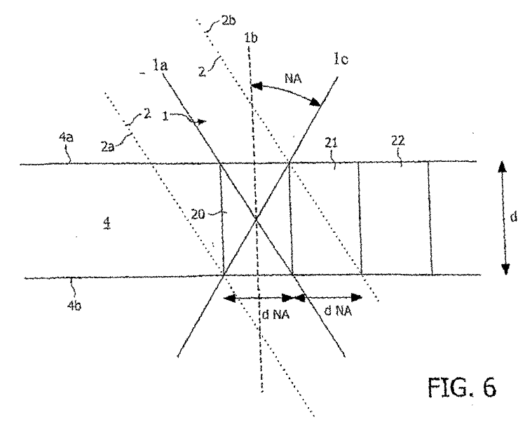

FIGS. 7(a) and 7(b) depict a schematic diagram illustrating the principle of recording and read-out using the phase-conjugate method; and

FIGS. 8(a) and 8(b) depict a schematic diagram illustrating the principle of recording and read-out according to an exemplary embodiment of the present invention.

### DETAILED DESCRIPTION OF THE INVENTION

In order to achieve both high density and excellent imaging, without the need for a short focal length lens system corrected for all aberrations, it has been proposed to use phase-conjugate readout of the volume holograms stored on a holographic data storage medium. After recording the object beam from the SLM with a reference beam, the hologram is reconstructed with a phase-conjugate (time-reversed copy) of the original reference beam. The diffracted wavefront then retraces the path of the incoming object beam, cancelling out any accumulated phase errors. This is intended to allow data pages to be retrieved with high fidelity using a low-performance lens, or even with no lens at all for an extremely compact system.

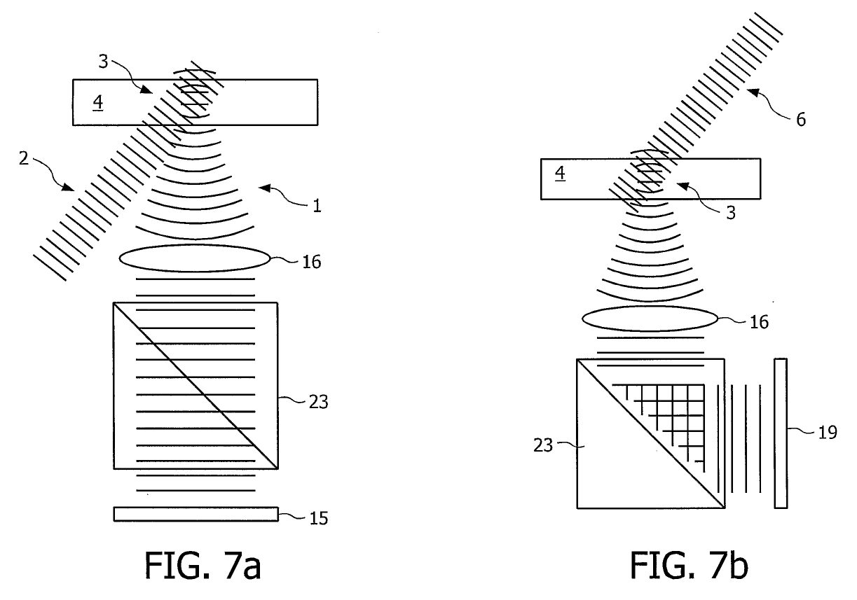

However, the known phase-conjugate read-out system described above with reference to FIGS. 7(a) and 7(b) of the drawings does not result in a fully reflective arrangement.

International Patent Application No. WO03/012782 describes a holographic storage apparatus, in which two focused beams (signal and reference) with a different focus point and/or polarization are incident on the same side of the storage medium, and read-out is performed as a result of reflection of one or other of the beams from a reflective surface of the medium.

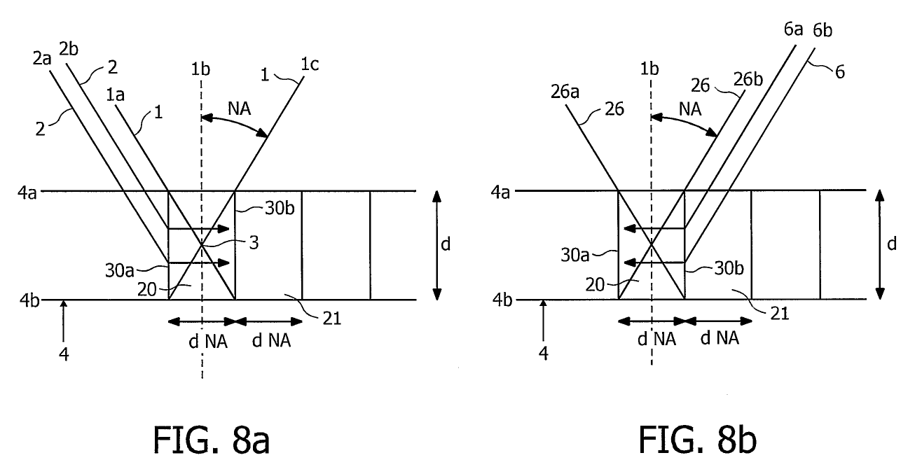

On the other hand, an exemplary embodiment of the present invention makes use of the space in the holographic medium that is not used to store data. As explained above, for conventional angular multiplexing the used volume fraction is about 50%. It is proposed to add a diffractive structure, either within the volume of one or more of the unused fractions of the holographic medium or at the boundaries between the used and unused fractions of the holographic medium, such that the reference wave is diffracted and enters the used volume substantially perpendicular to the optical axis of the signal wave. FIG. 8 shows the structure of the medium according to an exemplary embodiment of the invention. During recording the reference wave enters the used volume from the left, during read-out it enters the used volume from the right. This implies the presence of counter-propagating reference waves during recording and read-out, making the invention a method of phase-conjugate read-out. The advantage is that now the reference beam is at the same side of the storage medium as the signal and detection branches of the drive, so that a fully reflective system is accomplished.

Referring to FIG. 8(a) of the drawings, during recording, holographic medium 4 with top surface 4a and bottom surface 4b has a thickness d. The medium 4 may require a pre-exposure dose of light before it is capable of recording an interference grating. The signal wave 1 has outer rays 1a and 1c and a central ray along the optical axis 1b (dashed line), and has a numerical aperture NA, which (assuming it is sufficiently small compared to one) is equal to the top angle of the converging cone of light. The signal wave does not have a well-defined narrow focal point because it is not uniform (it is modulated with the checkerboard-pattern). In practice, it occupies the full grey volume 20, which has a width d*NA and a height d. The reference wave contains rays 2a and 2b (not all rays are drawn for the sake of clarity), and makes an angle of (at least) NA with the optical axis. The reference wave during recording is incident from the left on diffractive structure 30a, so that the reference wave enters the signal wave volume 20 substantially perpendicular to the optical axis.

Referring to FIG. 8(b) of the drawings, during read-out, the reference wave contains rays 6a and 6b (not all rays are drawn for the sake of clarity), and makes an angle of (at least) −NA with the optical axis, so axially opposite to the reference wave during recording. The reference wave during read-out is then incident from the right on diffractive structure 30b, so that the reference wave enters the signal wave volume 20 substantially perpendicular to the optical axis. The reference waves during recording and read-out propagate in opposite directions, implying that this is a form of phase-conjugate holography. The signal wave 26 with outer rays 26a and 26b generated during read-out therefore travels upward, back into the system.

In an alternative embodiment, a diffractive structure may be provided within, and be encompassed by, one or more unused portions 21 of the data storage volume, with the additional advantage that the diffractive structure can be made of the same photosensitive material as that used to make the recordable sections of the data storage volume of the holographic medium.

An exemplary method of manufacturing the diffractive structures will now be described. It uses the property of many photosensitive materials that they need a pre-exposure dose of light before interference gratings can be recorded.

In a first step of the manufacturing process the medium is made by applying a uniform layer of photo-sensitive material to a substrate.

In a second step the sections that are intended to become the non-recordable sections of the medium are exposed to dose of light exceeding the required pre-exposure dose, whereas the sections that are intended to become the recordable sections of the medium are not illuminated at all. This may be accomplished by illuminating the medium with a broad parallel beam through a mask.

In a third step the whole medium is illuminated with a wave propagating essentially parallel to the plane of the medium and with a wave making an angle α₁ with a normal to the medium. The interference grating between these waves is recorded only in the sections of the medium that have been illuminated with a dose of light exceeding the required pre-exposure. The procedure is repeated with the first wave propagating in the opposite direction and the second wave incident at an angle −α₁ with the normal to the medium. These last two steps are repeated for all other reference angles α₂ to α_{M}. The integrated dose of light used to create the interference gratings in the non-recordable sections should be lower than the required pre-exposure dose so as not to start writing in the recordable sections. The last step is the same as the second step, this time a dose of light is administered completely fixing the sections of the medium with the diffractive structures. This makes these sections non-recordable. However, other methods of forming the diffrative structures will be apparent to a person skilled in the art.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A holographic storage medium (4) comprising a data storage volume comprising a plurality of sections (20) in which data is recordable, and at least one section (21) in which data is not recordable, the, or at least one of, said non-recordable sections (21) including a diffractive structure (30b).

2. A holographic storage medium (4) according to claim 1, wherein said diffractive structure is provided within the volume of a respective non-recordable section (21).

3. A holographic storage medium (4) according to claim 1, comprising a diffractive structure (30b) located at one or more of the boundaries between said non-recordable sections (21) and adjacent recordable sections (20) of said data storage volume.

4. A holographic storage medium (4) according to claim 3, wherein said diffractive structure (30b) is planar.

5. A holographic storage medium (4) according to claim 1, wherein a signal wave (26) representative of data recorded thereon can be reproduced by illuminating said medium (4) with a reference wave (6) such that it is incident on said diffractive structure (30b), wherein said diffractive structure is arranged and configured to direct said reference wave (6) in a direction substantially perpendicular to the optical axis (16) of said signal wave (26) through an adjacent recordable section (20) to an interference region (3).

6. A method of manufacturing a holographic storage medium, said holographic storage medium comprising a data storage volume comprising a plurality of sections (20) in which data is recordable, and at least one section (21) in which data is not recordable, the, or at least one of, said non-recordable sections (21) including a diffractive structure (30b), said method comprising the steps of:
determining the sections (20) of said data storage volume which are recordable and sections (21) thereof which are not recordable,
providing a diffractive structure (30a, 30b) in respect of one or more of said sections (21) which are not recordable.

7. A method of phase-conjugate read-out of data in respect of a hologrphic medium (4), said holographic storage medium (4) comprising a data storage volume comprising a plurality of sections (20) in which data is recordable, and at least one section (21) in which data is not recordable, the, or at least one of, said non-recordable sections (21) including a diffractive structure (30b),
said method being intended to reproduce a signal wave (26) representative of data recorded thereon,
said method comprising a step of illuminating the holographic storage medium (4) with a reference wave (6) such that it is incident on a diffractive structure (30b) provided in respect of a non-recordable section (21) of the data storage volume and said diffractive structure (30b) causes the reference wave (6) to be directed in a direction substantially perpendicular to the optical axis (16) of said signal wave (26) through an adjacent recordable section (20) to an interference region (3) and detecting a resultant reconstructed signal wave (26).

8. An apparatus for phase-conjugate read-out of data in respect of a holographic medium (4), said holographic storage medium (4) comprising a data storage volume comprising a plurality of sections (20) in which data is recordable, and at least one section (21) in which data is not recordable, the, or at least one of, said non-recordable sections (21) including a diffractive structure (30b),
said apparatus being intended to reproduce a signal wave (26) representative of data recorded thereon, said apparatus comprising means for illuminating the holographic storage medium (4) with a reference wave (6) such that it is incident on a diffractive structure (30b) provided in respect of a non-recordable section (21) of the data storage volume and said diffractive structure (30b) causes the reference wave (6) to be directed in a direction substantially perpendicular to the optical axis (1b) of said signal wave (26) through an adjacent recordable section (20) to an interference region (3), and means (19) for detecting a resultant reconstructed signal wave (26).

9. A holographic data storage system comprising apparatus for phase-conjugate recording of data on a holographic data storage medium (4), said holographic storage medium (4) comprising a data storage volume comprising a plurality of sections (20) in which data is recordable, and at least one section (21) in which data is not recordable, the, or at least one of, said non-recordable sections (21) including a diffractive structure (30b),
said holographic data storage system also an apparatus according to claim 8 for phase-conjugate read-out of data in respect of said holographic data storage medium (4),
said apparatus for phase-conjugate recording of data comprising means (15) for directing a signal wave (1) toward an interference region (3) within a recordable section (20) of said holographic data storage medium (4), means for illuminating the holographic storage medium (4) with a reference wave (2) such that it is incident on a diffractive structure (30a) provided in respect of a non-recordable section (21) of the data storage volume and said diffractive structure (30a) causes the reference wave (2) to be directed in a direction substantially perpendicular to the optical axis (1b) of said signal wave (1) through an adjacent recordable section (20) to said interference region (3), and means for recording an interference pattern (5) created by interference of said signal wave (1) and said reference wave (2) at said interference region (3) as a refractive index modulation.

10. A holographic data storage system according to claim 9, wherein said reference waves (6, 2) for both data read-out and recording are incident on the holographic data storage medium (4) from the said side thereof, and wherein the reference wave (6) during read-out of data enters said recordable section (20) from a first direction and the reference wave (2) during recording of data enters the recordable section (20) from a second, opposite, direction.

11. A holographic data storage system according to claim 9, wherein said optical axis (1b) of the signal wave (1 or 26) is substantially perpendicular to the plane of the storage medium (4).

12. An apparatus according to claim 8, wherein the signal wave (2) is generated by passing a beam through a spatial light modulator (SLM) (15).

13. An apparatus according to claim 8, further comprising an optical element (16) for imaging the signal wave (1) onto the holographic medium (4).
